(19) United States
(12) Patent Application Publication
(10) Pub. No.: US 2024/0227742 A1
(43) Pub. Date: Jul. 11, 2024

(54) TIRE-TO-TIRE INFLATION SYSTEM, APPARATUS, AND METHOD

(71) Applicant: REXPAIR INDUSTRY LTD, Lansing, MI (US)

(72) Inventor: Yongbo Jiang, Lansing, MI (US)

(73) Assignee: REXPAIR INDUSTRY LTD, Lansing, MI (US)

(21) Appl. No.: 18/151,702

(22) Filed: Jan. 9, 2023

(51) Int. Cl. B60S 5/04; B60C 29/06

(52) U.S. Cl. CPC B60S 5/043; B60C 29/064; F16K 15/04

(57) ABSTRACT

A tire-to-tire pressure equalizing system includes: (a) a flexible conduit providing an airflow passageway therethrough; (b) a first coupler configured to connect to a first free end of the flexible conduit and engage with an air valve of a low-pressure tire; and (c) a second coupler having a check valve configured to connect to second free end of the flexible conduit and engage with an air valve of a high-pressure tire. The check valve is configured to allow air to transfer from the high-pressure tire to the low-pressure tire until an equilibrium is reached. A tee joint includes a connection for a first coupler and one or more conduits to allow for three or more tires to connect until an equilibrium is reached.

### TECHNICAL FIELD

The present disclosure relates generally to a tire inflation system, apparatus, and method.

### BACKGROUND

The statements in this section merely provide background information related to the present disclosure and may not constitute prior art.

Vehicles of all kinds assist individuals and society with transportation, whether that be for the transportation of people or of goods and commerce. Invariably, when that mode of transportation is disrupted, the disruption of the essential function of that transportation has ripple down effects, such as delays of the delivery of the goods or people. Certain vehicles, such as automobiles, trucks, motorcycles, bicycles, and airplanes, utilize tires. The tire holds air at a certain air pressure to give it a functional shape, firmness, and flexibility to help move the vehicle down a road or path and is often made from rubber. Maintaining the correct air pressure is desired to keep the tire functioning property. During vehicle use the tires may lose pressure at different rates. Therefore, it is difficult to maintain each tire individually at the same pressure.

During inflation, each tire needs to be inflated individually. While inflating each tire, it is difficult to pressurize each tire to the same pressure. Differing pressures between the tires can lead to asynchronous wearing of the vehicle's tires. Unequal wearing of tires can impact the vehicle safety because a user may be unaware of insufficient treading until after an accident.

Some commercial vehicles have multi-tire balancing systems however these systems are limited to tires that share the same axle or tires that are stacked on the same axles. Additionally, these systems are permanently mounted onto the vehicle or trailer and are reserved for large commercial vehicles. A need remains for an improved and convenient vehicle tire inflation system.

### SUMMARY

The present disclosure provides for a tire-to-tire pressure equalizing system including: (a) a conduit providing an airflow passageway therethrough; (b) a first coupler configured to connect to a first free end of the conduit and configured to engage with an air valve of a low-pressure tire; and (c) a second coupler having a check valve, connected to a second free end of the conduit, and configured to engage with an air valve of a high-pressure tire. The check valve is configured to allow air to transfer from the high-pressure tire to the low-pressure tire until an equilibrium is reached. The first coupler may include a collar configured to connect to a tire valve stem of the tire valve of the low-pressure tire. The conduit may be formed of a flexible material selected from the group consisting of rubber, silicone, polyvinyl chloride (PVC), nylon, vinyl, polypropylene, and polyethylene (PE).

In use, connecting the conduit to a low-pressure tire and a high-pressure tire allows for air to flow from the high-pressure tire to the low-pressure tire until an equilibrium is reached. The first coupler may include a head, a neck extending from the head, and an internal passage extending between them configured to allow airflow to pass therethrough. The first coupler may further include a friction band positioned around a portion of the neck and configured to securely connect to a free end of the conduit to form an air-tight seal between the conduit and the first coupler. The first coupler may further include a valve rod configured to allow airflow through the first coupler when engaged with a valve stem of the air valve of the low-pressure tire. The check valve of the second coupler is configured to allow air to flow between a high-pressure tire and a low-pressure tire and prevent back flow when an equilibrium is reached. The check valve may be a ball check valve.

The present disclosure further provides for a method for tire-to-tire inflation on a vehicle. The method includes the steps of: (a) providing a conduit connected to a first coupler at one free end and connected to a second coupler having a check valve at an opposite second free end; (b) connecting the first coupler to an air valve of a low-pressure tire of a vehicle; (c) connecting the second coupler to an air valve of a high-pressure tire of the vehicle; and (d) activating the check valve of the second coupler to open allowing air to flow between the high-pressure tire and the low-pressure tire until an equilibrium is reached. The first coupler may include a friction band positioned around a portion of the neck to securely connect to a free end of the conduit to form an air-tight seal between the conduit and the first coupler.

The present disclosure still further provides for a tire-to-tire air pressure equalizing system including: (a) one or more conduits having an airflow passageway therethrough; (b) a first coupler configured to connect to a free end of each of the one or more conduits and an air valve of a low pressure tire of a vehicle; (c) a plurality of tee joints, each having two male ports and a female port and a passageway therebetween, wherein each male port is configured to connect to the first coupler and the female port is configured to connect to an air valve of a vehicle tire; and (d) a check valve provided in the tee joint configured to restrict airflow provided within each male port. The first coupler is configured to depress the check valve upon connection and allow for airflow between a high-pressure vehicle tire to a low-pressure vehicle tire. The tee joints can be configured to allow for connecting to a plurality of conduits to connect three or more tires in a series. In use, the system is configured to allow for airflow to transfer between all the connected tires to equalize the air pressure between them. In an example, connecting the one or more conduits to the tires allows for four or more tires to pass air from a higher pressure tire to a lower pressure tire until an equilibrium is reached.

For purposes of summarizing the disclosure, certain aspects, advantages, and novel features of the disclosure have been described herein. It is to be understood that not necessarily all such advantages may be achieved in accordance with any one embodiment of the disclosure. Thus, the disclosure may be embodied or carried out in a manner that achieves or optimizes one advantage or group of advantages as taught herein without necessarily achieving other advantages as may be taught or suggested herein. The features of the disclosure which are believed to be novel are particularly pointed out and distinctly claimed in the concluding portion of the specification. These and other features, aspects, and advantages of the present disclosure will become better understood with reference to the following drawings and detailed description.

### BRIEF DESCRIPTION OF THE DRAWINGS

The figures which accompany the written portion of this specification illustrate example embodiments and methods of use for the present disclosure.

FIG. 1 illustrates a schematic of a tire tire-to-tire inflation system of the present disclosure.

FIG. 2 illustrates a perspective view of a coupler for use with the system of the present disclosure.

FIG. 3 illustrates a cross-section of the coupler of FIG. 2.

FIG. 4A illustrates a cross section of a dual tire tire-to-tire inflation apparatus of the present disclosure.

FIG. 4B illustrates a schematic of a tire-to-tire inflation system and apparatus connecting a high-pressure tire and a low-pressure tire.

FIG. 5 illustrates a tee joint for use with a four-tire tire-to-tire inflation system of the present disclosure.

FIG. 6 illustrates a schematic diagram of a four-way tire-to-tire inflation system of the present disclosure.

The various embodiments of the present disclosure will hereinafter be described in conjunction with the appended drawings, wherein like designations denote like elements.

### DETAILED DESCRIPTION

The following description is merely exemplary in nature and is not intended to limit the present disclosure, application, or uses. It should be understood that throughout the drawings, corresponding reference numerals indicate like or corresponding parts and features.

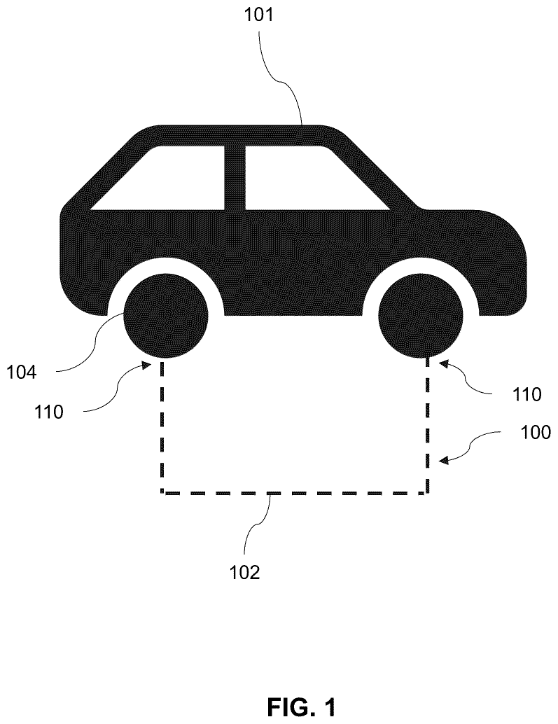

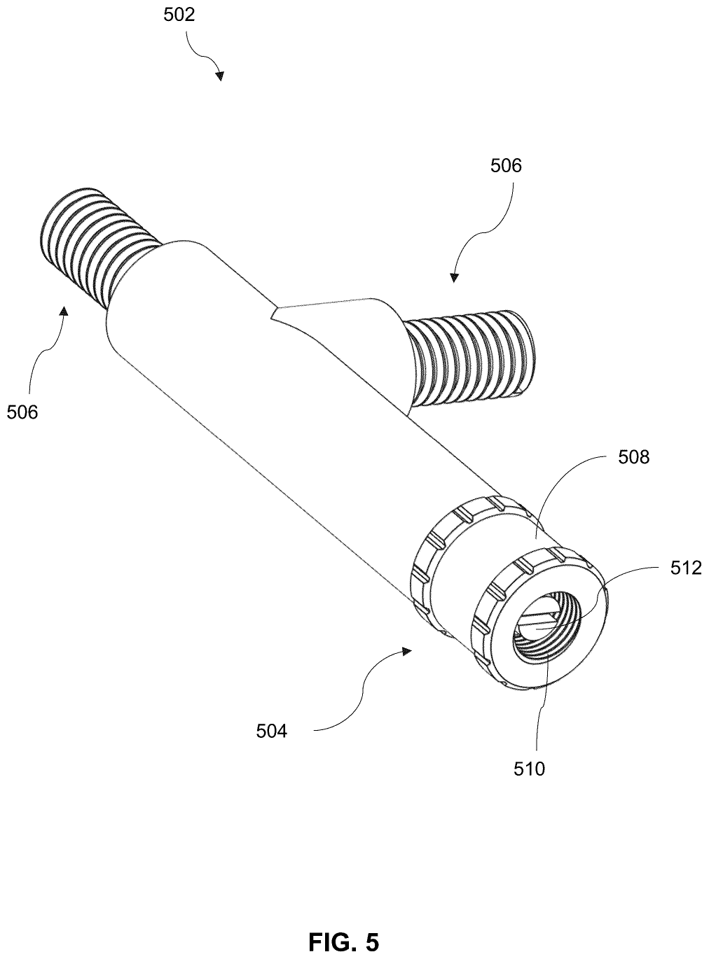

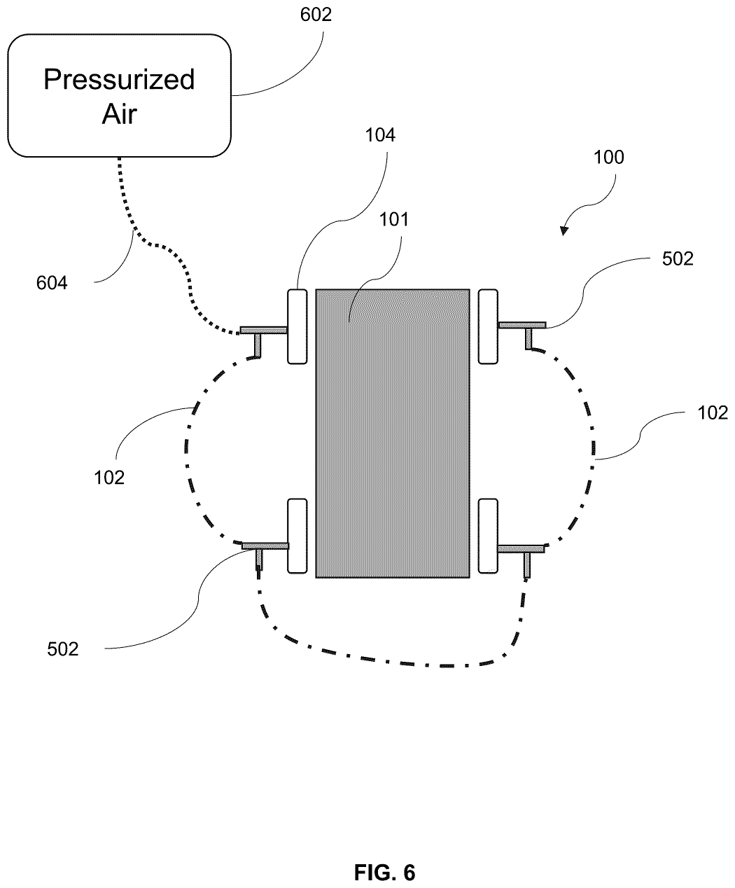

Referring to FIGS. 1-6, the present disclosure provides for a tire-to-tire inflation system and/or apparatus 100 and method of use thereof. Tire-to-tire inflation system 100 may be configured to equalize pressure between two or more tires 104. In this example, the tires are part of a vehicle 101. Tire-to-tire inflation system 100 includes a conduit 102 providing an airflow passageway therethrough. Conduit 102 includes at least two opposite “free” ends 110 or connection ends 110 for connecting to a valve stem of a tire 104 or another device. Each free end 110 of the conduit 102 is configured to connect to a coupler 204. Conduit 102 can be considered a “flexible” conduit made from material that allows for physical movement around a vehicle to assist with access to the tires.

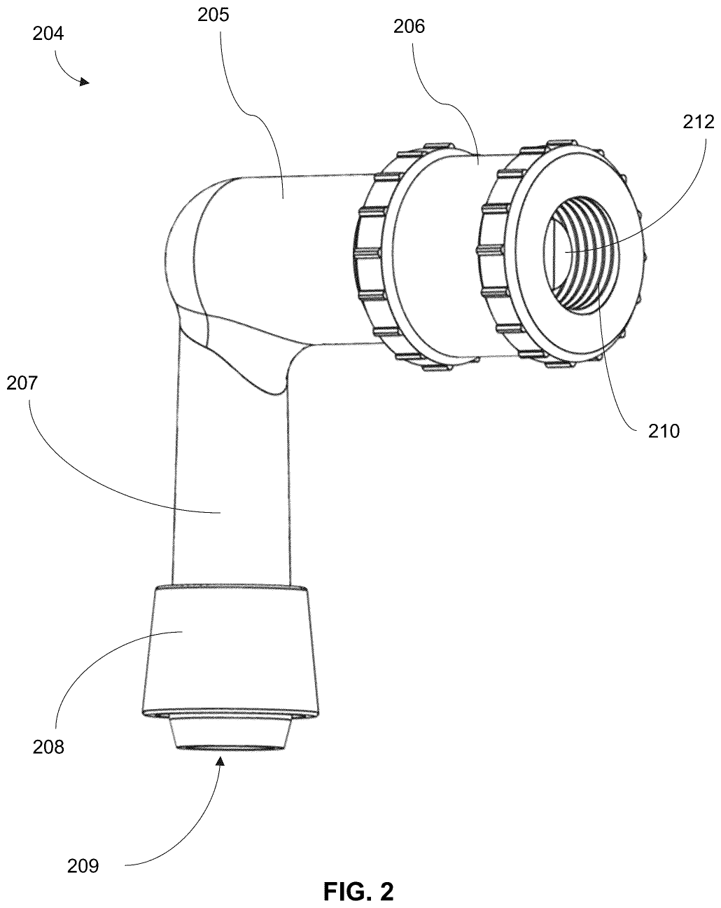

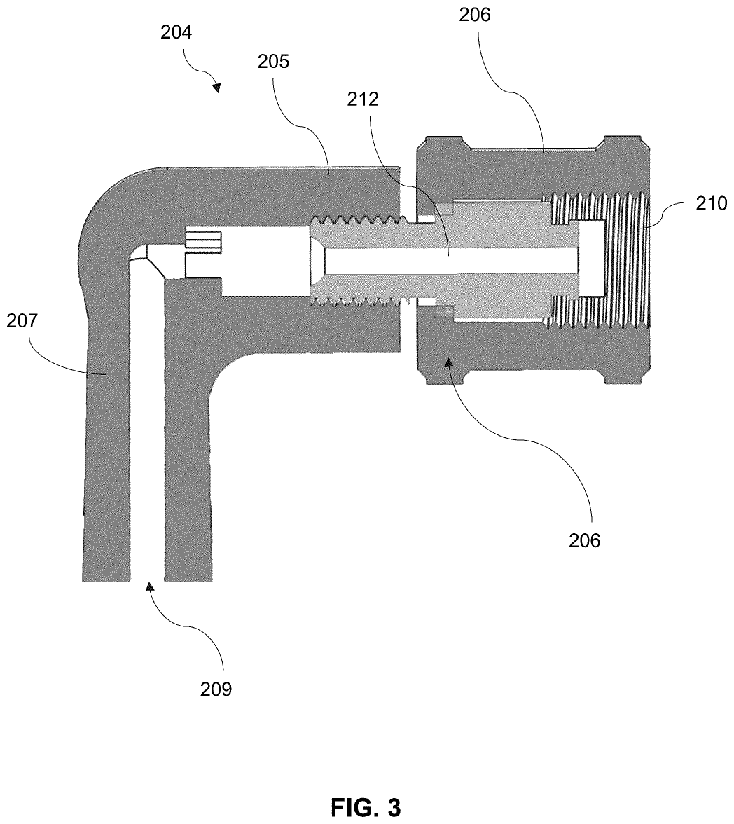

In an example, a first coupler 204 may include a head 205, a neck 207, a collar 206, a flow valve 212, and. a friction band 208. In this example, first coupler 205 includes an internally threaded fitting 210. Coupler 204 defines an internal passage for fluid to flow therethrough extending from collar 206 through head 205, through neck 207, and out coupler opening 209. In this example, neck 207 extends from head 205 in substantially a perpendicular relationship. The flow valve 212 is configured to control, limit, and/or prevent undesired back flow or forward flow of the fluid passing through coupler 204. FIGS. 2-3 show an example valve rod 212 for first coupler 204.

First coupler 204 can be connected to conduit 102 by a friction fit or a secure fit of the flexible conduit 102 partially overlapping neck 207 at or near the connection end 110. In an example, an elastomeric friction band 208 is provided to slide over the conduit 102 on the partially overlapped neck 207, to at least partially surround both conduit 102 and neck 207 and form an air-tight seal between the two for sufficient airflow. Friction band 208 is configured to provide a fluid seal by circumferentially constricting conduit 102 around neck 207. Thus, providing a sealed fluid connection between first coupler 204 and conduit 102.

In an example, first coupler 204 is configured to connect to a SCHRADER valve stem or PRESTA valve stem of tire 104. First couplers 204 include a collar 206 attached at each free end 110. Collar 206 may define an internally threaded fitting 210. The internally threaded fitting 210 is configured to connect on to a complementary valve stem of the tire. The internally threaded fitting 210 may be formed of the same material as first coupler 204 or it may be formed of a durable or corrosion resistant material such as but not limited to brass, copper, aluminum, steel, or zinc.

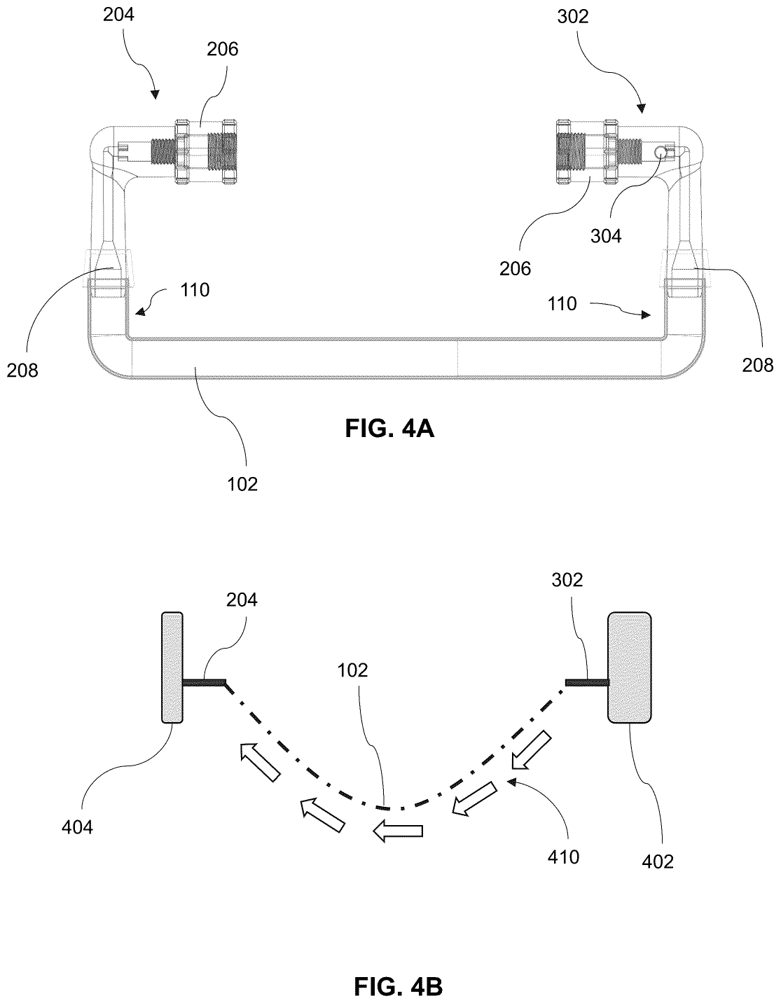

In an example, system 100 fluidly connects between at least two tires 104. The tires 104 may be filled with air of differing pressures or one tire may have no or little air at all. In this example, a second coupler 302 is connected to a free end 110 of conduit 102 that engages a tire valve stem on a high-pressure tire 402 (See FIGS. 4A and 4B). Second coupler 302 can be a ball coupler. First coupler 204 on an opposite end 110 of conduit 102 engages a tire valve stem on a low-pressure tire 404. In an example, ball coupler 302 houses a ball-check valve 304 fluidly connected to conduit 102. Ball-check valve 302 provides a mechanical mechanism for preventing backflow of air within system 100. As the first coupler 204 is attached to low-pressure tire 404, a fluid connection between the tires 402 and 404 is formed and a pathway for air transfer between the tires results.

In use, when ball-check valve 304 is attached to a high-pressure tire 402, the ball-check valve 304 should open once it reaches its cracking pressure. As the ball-check valve 304 opens, air is allowed to flow from the high-pressure 402 tire to low-pressure tire 404 (as shown by airflow path 410) until an equilibrium between the tires is reached. Once equilibrium is reached between the tires 402 and 404, ball check valve 302 returns to a closed state and prevents back flow.

The present disclosure provides for a method of use of system/apparatus 100. To operate system 100, first coupler 204 is connected onto the valve stem of a low-pressure tire 404. During the time that first coupler 204 is attached to the low-pressure tower 404 but second coupler 302 (in this example, ball coupler 302) is not yet installed, air loss is prevented by ball-check valve 304. Ball-check valve 304 housed within ball coupler 302 can prevent air loss from low-pressure tire 404 due to the typically higher pressure of low-pressure tire 404 in relation to the atmospheric external pressure.

Next, ball coupler 302 is connected to the high-pressure tire 402. Once ball coupler 302 is mounted, ball check valve 304 opens and allows air to transfer from high-pressure tire 402 to the low-pressure tire 404. When an equilibrium in pressure is reached between the tires, ball valve 304 closes to prevent backflow. To remove system 100, ball coupler 302 is first removed from the air delivering high pressure tire 402 to prevent loss of pressure. Next first coupler 204 is removed from the air receiving tire low-pressure tire 404.

In another example, the present disclosure provides for a system 100 configured to equalize pressure among three or more tires 104 of a vehicle 101, including a system that can equalize four tires of a standard vehicle. A tee-joint 502 is configured to provide connection to the air valves of each tire 104. Tee-joint 502 is configured to attach to one or two conduits 102 and allow for connecting the four tires 104 in series.

In an example, tee joint 502 includes three attachment ports—a female port 504 configured to attach to a vehicle tire 104, and two male ports 506. Male port 506 may provide a point of connection between a plurality of tee joints 502. In an example both male ports 506 include valves limiting airflow such as Schrader valves. The valves of male ports 506 prevent air backflow during installation of tee-joints 502.

In an example, one of the male ports 506 of tee joint 502 is connected to a first coupler 204 of conduit 102. Conduit 102 provides a fluid connection between two or more valve stems (not shown) which are individually provided on tires 104.

System 100 is configured to equalize pressure between four tires 104 of a vehicle 101. In this example, the female port 504 of each tee joint 502 is connected to an air valve stem of each tire 104. Each female port 504 includes a collar assembly 508 configured to attach to the air valve stem of tire 104.

Collar 508 may include an internally threaded fitting 510 and a rod 512. Threaded fitting 510 is configured to screw onto a complementary threaded stem of an air valve of tire 104. In an axial direction down the length of tee-joint 502, rod 512 is positioned coaxially within female port 204 so that when internal threaded fitting 510 of female port 204 is connected to the complementary stem (not shown) of an air valve, rod 512 depresses the air valve and allows the air to flow through.

In another example, system 100 provides tire pressure balancing between four vehicle tires with varying pressures. A tee-joint 502 is attached to each of tires 104 by connecting female port 504 to a valve stem of a vehicle tire 104. Three conduits 102, each providing at least one of a first coupler 204 on a free end 110 are provided and are each attached to a tee-joint 502.

First coupler 204 attaches to male port 506 of tee-joint 502. Each male port 506 is configured as a valve limiting airflow such as a Schrader valve. First coupler 204 is connected to male port 506 by a collar 206. As first coupler 204 is connected, valve rod 212 depresses the valve, allowing air to flow.

The first coupler 204 at the opposite end of conduit 102 is attached to a male port 506 of another tee joint 502 on another tire 104. Once both first couplers 204 are attached to each of their respective tires 104, a fluid connection is formed between the tires 104 allowing the tire pressures to equalize. The valves arranged within the free male ports 506 of each tee joint 502 prevent air loss to the environment during operation.

In an example multiple tee joints 502 may be connected in series by multiple conduits 104. In a further example, third and fourth tires 104 may be connected by attaching tee joints 502 to each tire 104. Tee joints 502 are fluidly connected in series by a second and third conduit 102 each with first coupler 204 connected at a free end 110. First coupler 204 connects at a free male port 506 of tee joint 502 creating an air path for pressure equalization between the four tires. In this configuration two tee joints 502 are connected to conduit 102 at both male ports 506 and two tee joints 502 are connected to conduit 102 at one male port 506 leaving the other male port 506 of each tee joint 502 free. The valves within free male ports 506 prevent pressure loss to the environment.

In yet a further example, a source of pressurized air 602 can be attached to an air hose 604 configured to deliver pressurized air from the source 602 to the four vehicle tires through system 100. Hose 604 may be attached to a free male port 506 of tee joint 502. By introducing pressurized air to the apparatus 100, air is supplied to each tire 104 at an equal pressure.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A tire-to-tire pressure equalizing system comprising:
(a) a conduit providing an airflow passageway therethrough;
(b) a first coupler configured to connect to a first free end of the conduit and configured to engage with an air valve of a low-pressure tire; and
(c) a second coupler having a check valve, configured to connect to a second free end of the conduit, and configured to engage with an air valve of a high-pressure tire;
wherein, the check valve is configured to allow air to transfer from the high-pressure tire to the low-pressure tire until an equilibrium is reached.

2. The tire-to-tire pressure equalizing system according to claim 1, wherein the first coupler includes a collar configured to connect to a tire valve stem of the air valve of the low-pressure tire.

3. The tire-to-tire pressure equalizing system according to claim 1, wherein the conduit is formed of a flexible material selected from the group consisting of rubber, silicone, polyvinyl chloride (PVC), nylon, vinyl, polypropylene, and polyethylene (PE).

4. The tire-to-tire pressure equalizing system according to claim 1, wherein connecting the conduit to the low-pressure tire and the high-pressure tire allows for air to flow from the high-pressure tire to the low-pressure tire until an equilibrium is reached.

5. The tire-to-tire pressure equalizing system according to claim 1, wherein the first coupler includes a head, a neck extending from the head, and an internal passage extending between them configured to allow airflow to pass therethrough.

6. The tire-to-tire pressure equalizing system according to claim 5, wherein the first coupler includes a friction band positioned around a portion of the neck and configured to securely connect to a free end of the conduit to form an air-tight seal between the conduit and the first coupler.

7. The tire-to-tire pressure equalizing system according to claim 1, wherein the first coupler includes a valve rod configured to allow airflow through the first coupler when engaged with the air valve of the low-pressure tire.

8. The tire-to-tire pressure equalizing system according to claim 1, wherein the check valve of the second coupler is configured to allow air to flow between the high-pressure tire and the low-pressure tire and prevent back flow when an equilibrium is reached.

9. The tire-to-tire pressure equalizing system according to claim 8, wherein the check valve is a ball check valve.

10. A method for tire-to-tire inflation on a vehicle comprising the steps of:
(a) providing a conduit connected to a first coupler at one free end and connected to a second coupler having a check valve at an opposite second free end;
(b) connecting the first coupler to an air valve of a low-pressure tire of a vehicle;
(c) connecting the second coupler to an air valve of a high-pressure tire of the vehicle; and
(d) activating the check valve of the second coupler to open allowing air to flow between the high-pressure tire and the low-pressure tire until an equilibrium is reached.

11. The method for tire-to-tire inflation on a vehicle according to claim 10, wherein the first coupler includes a collar to connect to a tire valve stem of the air valve of the low-pressure tire.

12. The method for tire-to-tire inflation on a vehicle according to claim 10, wherein the first coupler includes a head, a neck extending from the head, and an internal passage extending between them to allow airflow to pass therethrough.

13. The method for tire-to-tire inflation on a vehicle according to claim 12, wherein the first coupler includes a friction band positioned around a portion of the neck and securely connects to a free end of the conduit forming an air-tight seal between the conduit and the first coupler.

14. The method for tire-to-tire inflation on a vehicle according to claim 10, wherein the first coupler includes a valve rod to allow airflow through the first coupler when engaged with a valve stem of the air valve of the low-pressure tire.

15. The method for tire-to-tire inflation on a vehicle according to claim 10, wherein the check valve of the second coupler allows air to flow between the high-pressure tire and the low-pressure tire and prevent back flow when an equilibrium is reached.

16. The method for tire-to-tire inflation on a vehicle according to claim 10, wherein the check valve is a ball check valve.

17. A tire-to-tire air pressure equalizing system comprising:
(a) one or more conduits having an airflow passageway therethrough;
(b) a first coupler configured to connect to a free end of each of the one or more conduits and to an air valve of a vehicle tire;
(c) a plurality of tee joints, each having two male ports and a female port and a passageway therebetween, wherein each male port is configured to connect to the first coupler and the female port is configured to connect to an air valve of a different vehicle tire; and
(d) a check valve provided in the tee joint configured to restrict airflow provided within each male port;
wherein the first coupler is configured to depress the check valve upon connection and allow for airflow between a high-pressure vehicle tire to a low-pressure vehicle tire.

18. The tire-to-tire pressure equalizing system according to claim 17, wherein the plurality of tee joints are configured to connect to a plurality of conduits to connect three or more tires in a series.

19. The tire-to-tire pressure equalizing system according to claim 17, wherein connecting the one or more conduit to the low-pressure tire and the high-pressure tire allows for airflow to transfer therebetween to equalize the air pressure between them.

20. The tire-to-tire pressure equalizing system according to claim 17, wherein connecting the one or more conduits to a plurality of vehicle tires allows for four or more tires to pass air from a higher pressure tire to a lower pressure tire until an equilibrium is reached.
